(19) United States
(12) Patent Application Publication
(10) Pub. No.: US 2013/0285337 A1
(43) Pub. Date: Oct. 31, 2013

(54) ALL TERRAIN SLED

(71) Applicant: Mark Palagyi, Huntington Beach, CA (US)

(72) Inventor: Mark Palagyi, Huntington Beach, CA (US)

(21) Appl. No.: 13/459,232

(22) Filed: Apr. 29, 2012

(51) Int. Cl. B62B 13/18; B62B 17/00

(52) U.S. Cl. 280/8; 280/18

(57) ABSTRACT

An all-terrain sled that allows a user to easily pull cargo over any terrain. The sled includes a bottom shape that provides, with forward movement, lift over soft terrain. Cut out areas in the bottom of the all-terrain sled reduce surface drag by minimizing contact area. A leading edge of the cut out area may be disposed with an angle that can move soft surface material, such as sand, into the cut out area. A trailing edge of the cut out area may be disposed with an angle that can provide lift for the sled when moving it forward while guiding the material out to the side of the sled. The sled may include wheels on each side at one end of the sled for ease of movement over smooth terrain.

### BACKGROUND OF THE INVENTION

The present invention relates to sleds and, more particularly, to an all-terrain sled that can pull cargo over any terrain.

Conventional sled bases are typically flat members with, perhaps, a curved front, for pulling cargo over a surface. Due to their large contact area (the entire base), there is usually high friction between the base and the surface. Moreover, if pulling the sled over a soft surface, such as sand, the base is even harder to pull, as the soft surface can increase friction.

As can be seen, there is a need for an improved all-terrain sled that may be used to easily pull cargo over a variety of surfaces.

### SUMMARY OF THE INVENTION

In one aspect of the present invention, a sled comprises a bottom surface having a plurality of cut out regions formed therein; a leading edge of the cut out regions having a curvature to force material of a surface into the cut out regions; and a trailing edge having an angle, relative to the cut out region, to provide lift to the sled when the sled is moved forward.

In another aspect of the present invention, a sled comprises a bottom surface having a plurality of cut out regions formed therein; a leading edge of the cut out regions having a curvature to force material of a surface into the cut out regions; and a trailing edge having a larger radius of curvature as compared to the curvature of the leading edge.

In a further aspect of the present invention, a sled comprises a bottom surface having a plurality of cut out regions formed therein; a leading edge of the cut out regions having a curvature to force material of a surface into the cut out regions; a trailing edge having an angle, relative to the cut out region, to provide lift to the sled when the sled is moved forward; and a sloped front edge of the sled, wherein the trailing edge having a larger radius of curvature as compared to the curvature of the leading edge.

These and other features, aspects and advantages of the present invention will become better understood with reference to the following drawings, description and claims.

### BRIEF DESCRIPTION OF THE DRAWINGS

FIG. 1 is a back, bottom perspective view of an all-terrain sled according to an exemplary embodiment of the present invention;

FIG. 2 is a side view of the all-terrain sled of FIG. 1;

FIG. 3 is a top, front perspective view of the all-terrain sled of FIG. 1;

FIG. 4 is a front, bottom perspective view of the all-terrain sled of FIG. 1;

FIG. 5 is a back, bottom perspective view of an all-terrain sled with wheels according to an exemplary embodiment of the present invention;

FIG. 6 is a side view of the all-terrain sled of FIG. 5;

FIG. 7 is a front, bottom perspective view of the all-terrain sled of FIG. 1;

FIG. 8 is a perspective view of the all-terrain sled of FIG. 5 applied to an ice chest; and

FIG. 9 is a perspective view of the all-terrain sled of FIG. 5 applied to a sand sled.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an all-terrain sled that allows a user to easily pull cargo over any terrain. The sled includes a bottom shape that provides, with forward movement, lift over soft terrain. Cut out areas in the bottom of the all-terrain sled reduce surface drag by minimizing contact area. A leading edge of the cut out area may be disposed with an angle that can move soft surface material, such as sand, into the cut out area. A trailing edge of the cut out area may be disposed with an angle that can provide lift for the sled when moving it forward while guiding the material out to the side of the sled. The sled may include wheels on each side at one end of the sled for ease of movement over smooth terrain.

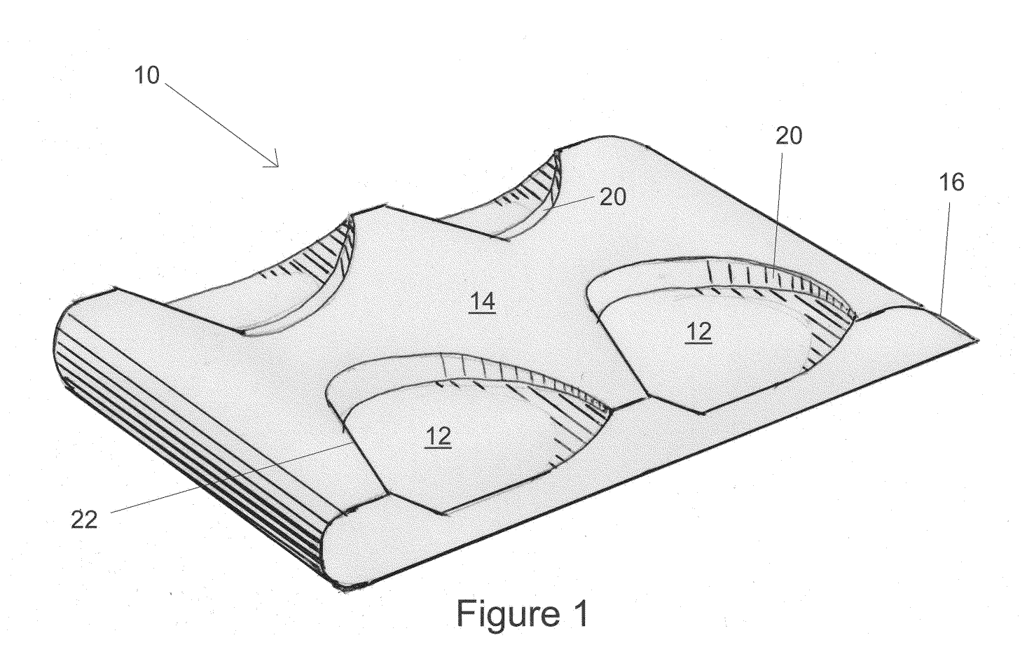

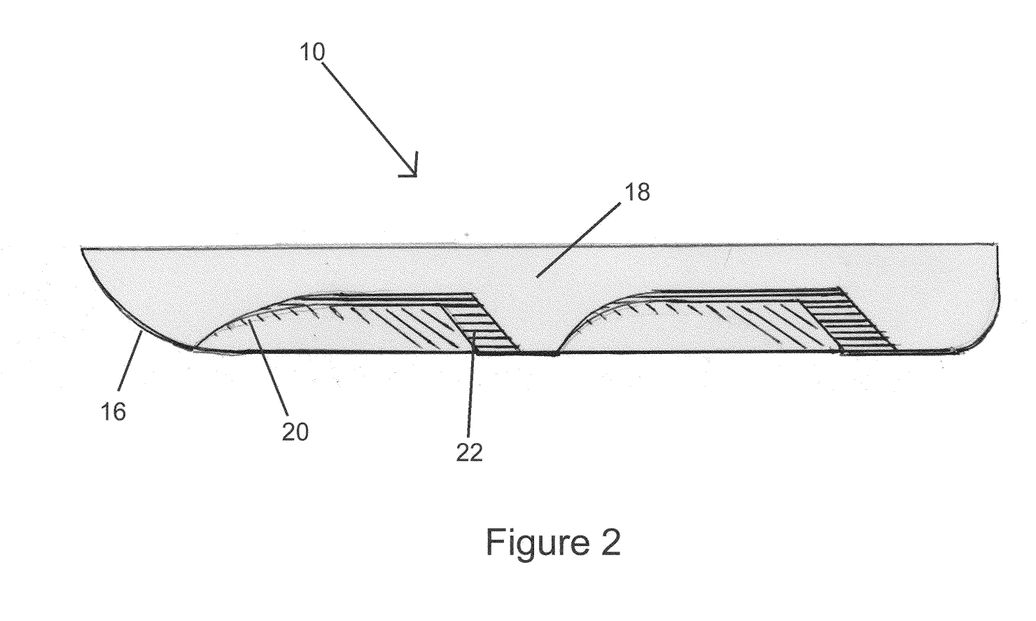

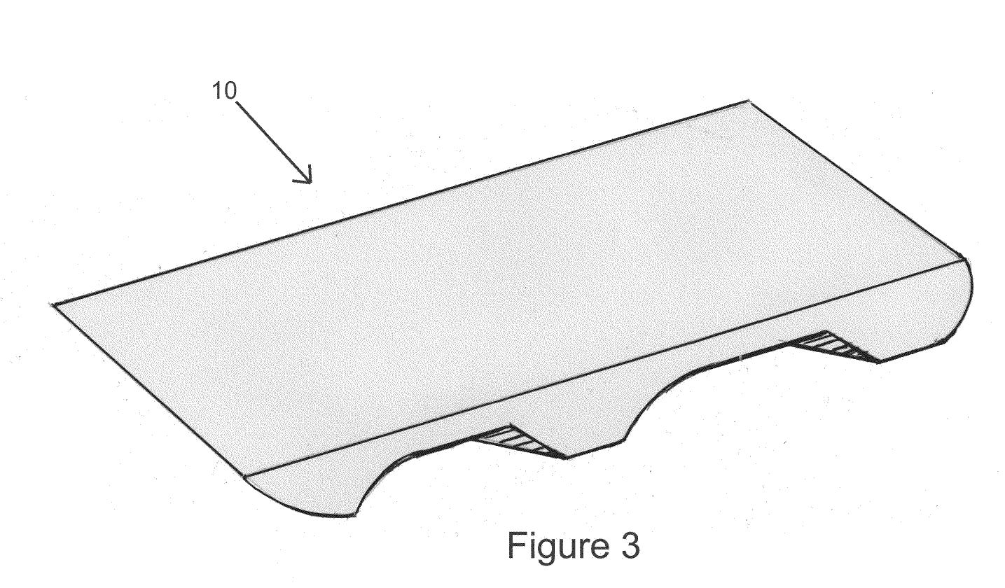

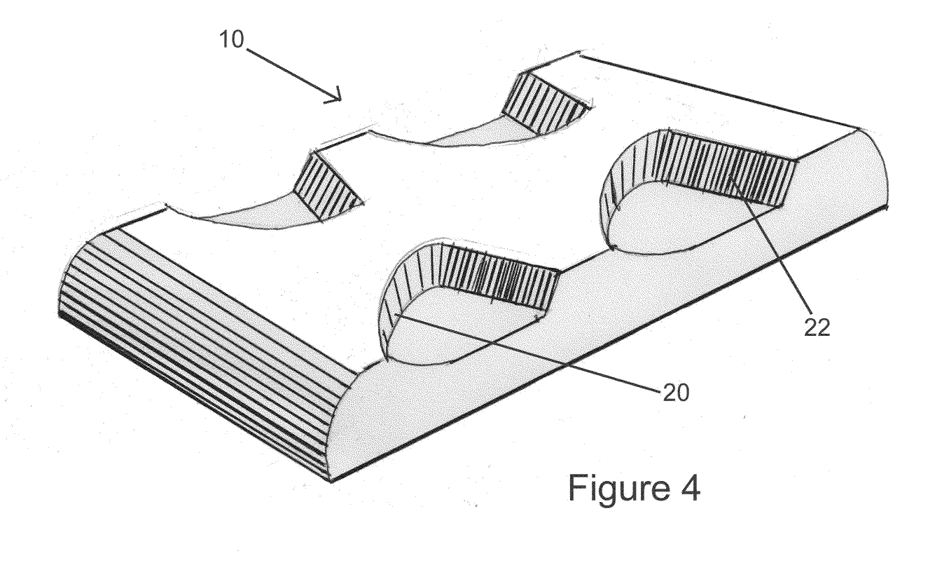

Referring now to FIGS. 1 through 4, an all-terrain sled 10 (also referred to a sled 10) may include cut out regions 12 at a bottom surface 14 of the sled 10. A front end 16 of the sled 10 may be curved from the bottom to smooth transition when pulling the sled in a forward motion. Typically, there may be four cut out regions 12 extending from a side 18 of the sled 10 toward a center of the sled 10. In some embodiments, two, six, or more cut out regions 12 may be disposed at the bottom 14 of the sled 10.

A leading edge 20 of the cut out regions 12 may be curved to direct material (such as surface material, such as sand) into the cut out regions 12. A trailing edge 22 of the cut out regions 12 may be straight or nearly straight or at least has a larger radius of curvature as compared to the leading edge 20. This trailing edge 22 design may provide help move material to the side of the sled 10. The trailing edge 22 may also be cut at an angle 24 relative to the cut out region 12. This angle 24 may direct material to provide lift of the sled 10.

The combined features of the cut out regions 12, including the design of the leading edges 20 and the trailing edges 22, provides a sled that may be moved easier, as compared to convention flat-bottomed sleds, over all terrain, especially soft terrain, such as sand.

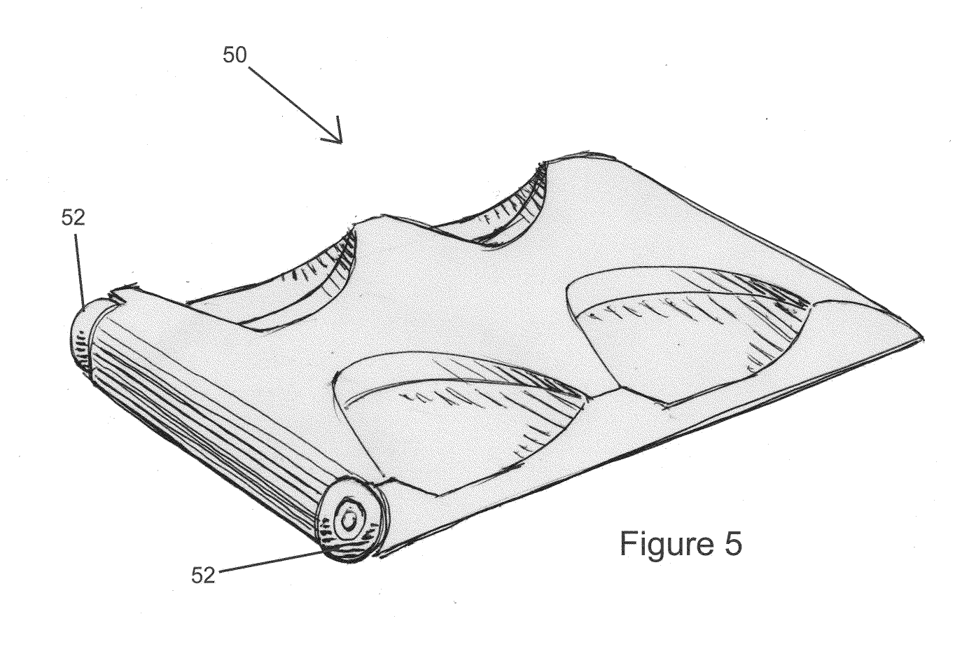

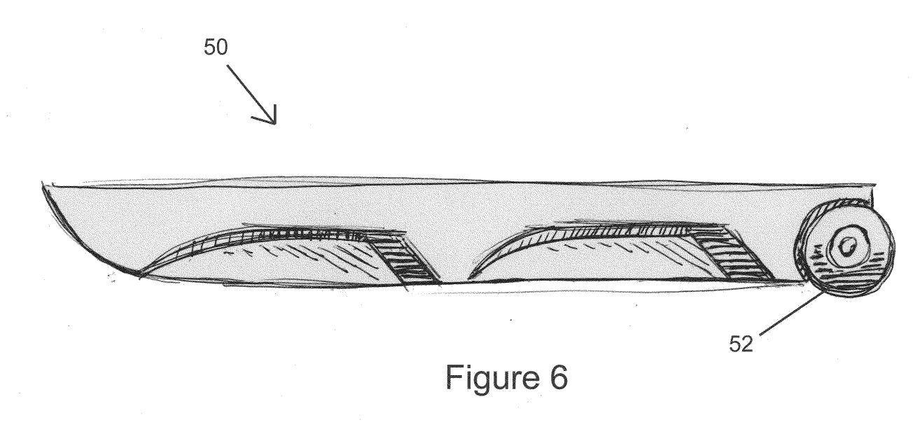

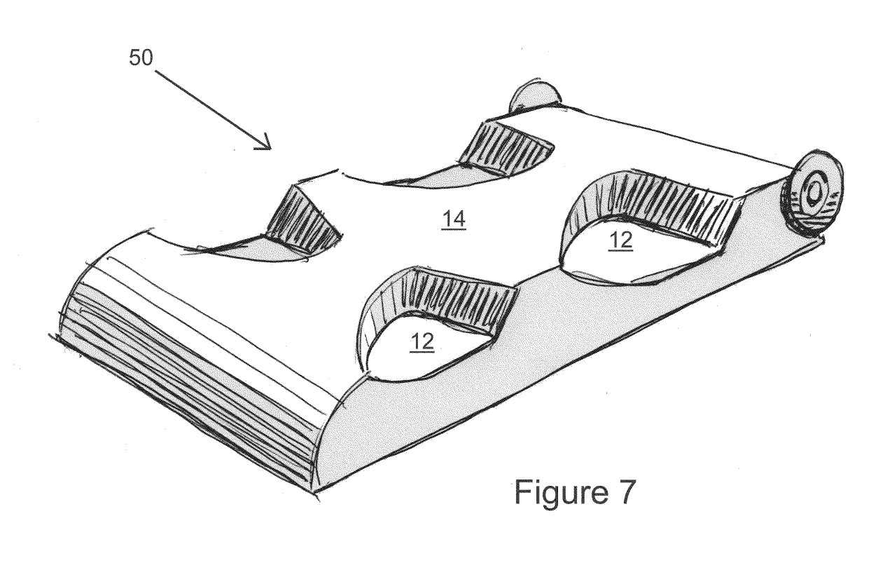

Referring now to FIGS. 5 through 7, an all-terrain sled 50 (also referred to as sled 50) may include wheels 52 formed on a trailing end 54 thereof. Typically, one wheel 52 may be disposed on each side of the training end of the sled 50. The wheels 52 may permit the sled 50 to dolly cargo over hard terrain with ease. The sled 50 may include the features of the sled 10, such as the cut out regions 12 having the specially designed trailing edges 22 and the leading edges 20.

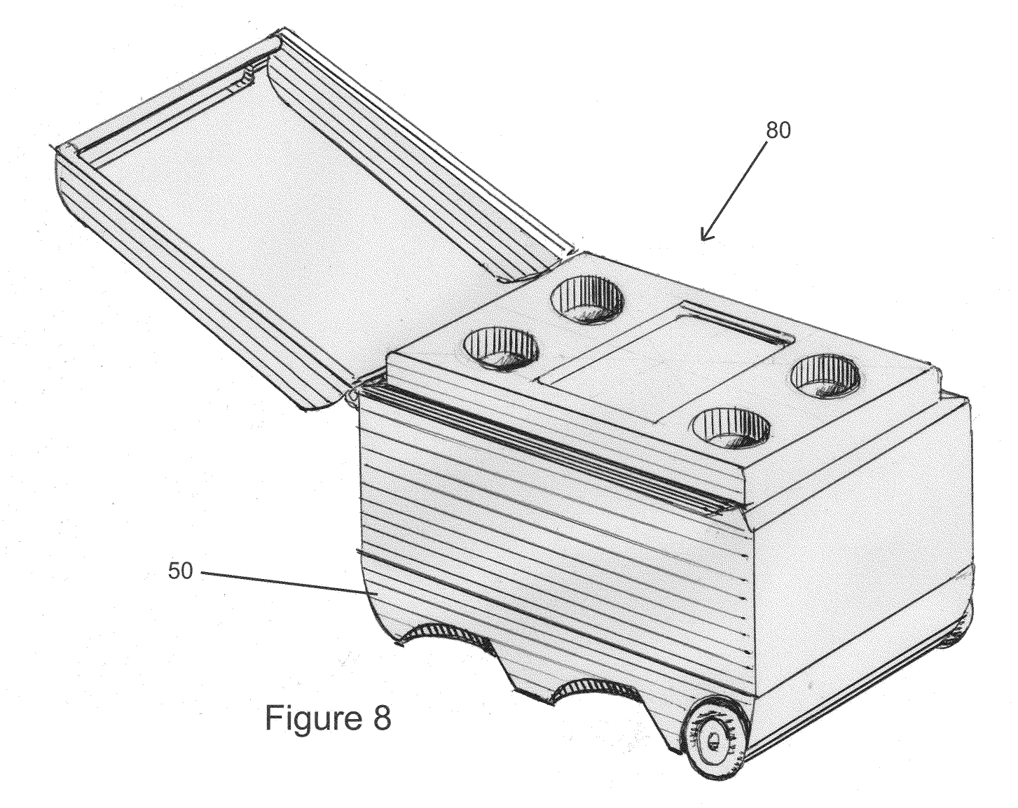

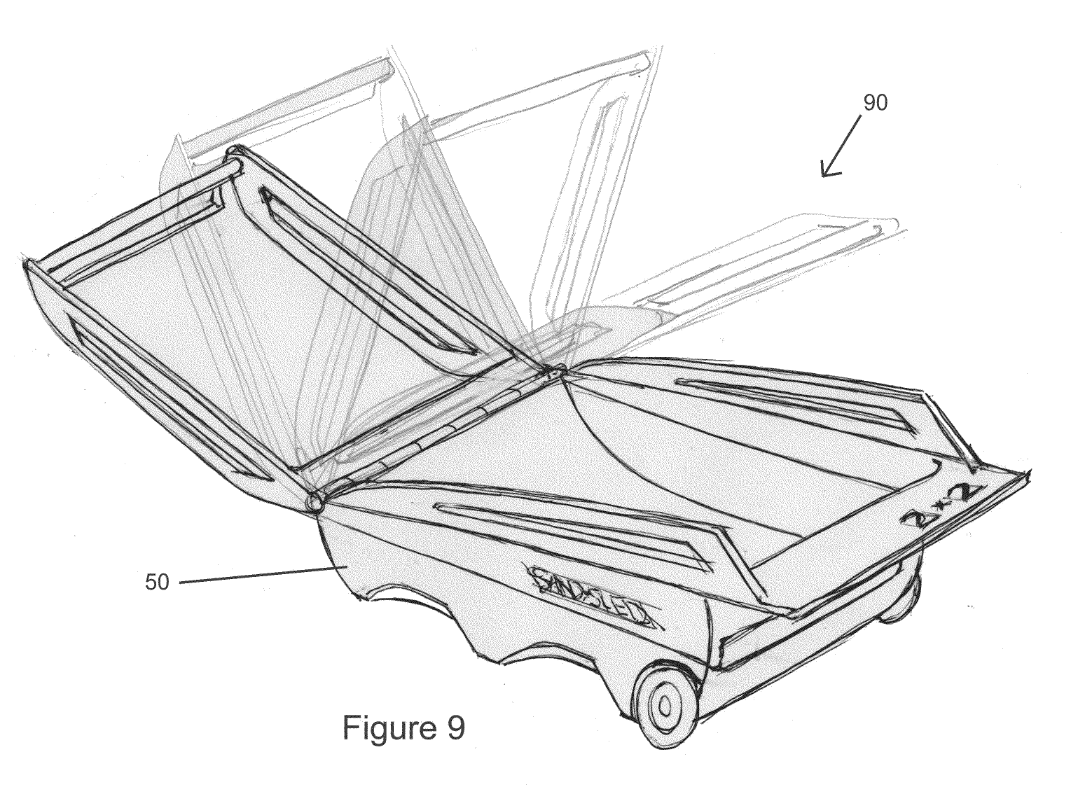

Referring to FIGS. 8 and 9, the sled 50 (or, alternatively, the sled 10) may be used to carry a variety of items or may be formed as part of a variety of items. For example, an ice chest 80 may use the sled 50 as its base. As a second example, a sand sled 90 may use the sled 50 as its base. Of course, other items to use the sled 10, 50 as a base, may be contemplated within the scope of the present invention.

It should be understood, of course, that the foregoing relates to exemplary embodiments of the invention and that modifications may be made without departing from the spirit and scope of the invention as set forth in the following claims.

What is claimed is:

1. A sled comprising:
a bottom surface having a plurality of cut out regions formed therein;
a leading edge of the cut out regions having a curvature to force material of a surface into the cut out regions; and
a trailing edge having an angle, relative to the cut out region, to provide lift to the sled when the sled is moved forward.

2. The sled of claim 1, wherein the trailing edge has a larger radius of curvature as compared to the curvature of the leading edge.

3. The sled of claim 1, further comprising a sloped front edge of the sled.

4. The sled of claim 1, further comprising wheels on a back end of the sled.

5. The sled of claim 1, wherein the wheels are disposed one on each side of the back end of the sled.

6. A sled comprising:
a bottom surface having a plurality of cut out regions formed therein;
a leading edge of the cut out regions having a curvature to force material of a surface into the cut out regions; and
a trailing edge having a larger radius of curvature as compared to the curvature of the leading edge.

7. The sled of claim 6, further comprising a sloped front edge of the sled.

8. The sled of claim 6, further comprising wheels on a back end of the sled.

9. A sled comprising:
a bottom surface having a plurality of cut out regions formed therein;
a leading edge of the cut out regions having a curvature to force material of a surface into the cut out regions;
a trailing edge having an angle, relative to the cut out region, to provide lift to the sled when the sled is moved forward; and
a sloped front edge of the sled, wherein
wherein the trailing edge having a larger radius of curvature as compared to the curvature of the leading edge.

10. The sled of claim 9, further comprising wheels on a back end of the sled.
